(19) United States
(12) Patent Application Publication
(10) Pub. No.: US 2014/0373409 A1
(43) Pub. Date: Dec. 25, 2014

(54) STRUCTURED WRAP AND METHOD OF USING SAME

(71) Applicants: Jeremy Daniel Blanks, Parkton, NC (US); Jian Sun-Blanks, Parkton, NC (US)

(72) Inventors: Jeremy Daniel Blanks, Parkton, NC (US); Jian Sun-Blanks, Parkton, NC (US)

(21) Appl. No.: 14/309,988

(22) Filed: Jun. 20, 2014

Related U.S. Application Data
(60) Provisional application No. 61/838,291, filed on Jun. 23, 2013.

(51) Int. Cl. G09F 21/04

(52) U.S. Cl. CPC G09F 21/04
USPC 40/592

(57) ABSTRACT

A structured wrap includes an inner support member and a cover enclosing the support member. The wrap can be attached to a cylindrical, cubic, rectangular or similar object, such as a vehicle roof/luggage rack, rear spoiler or a standalone component, such as a fence or pole. The wrap can allow for advertising or promotion of personal interests, as well as protection of the rack or component itself from scratches or other damage from normal use.

### CROSS REFERENCE TO RELATED APPLICATIONS

This application claims priority to U.S. Provisional Patent Application No. 61/838,291, filed Jun. 23, 2013, and which is incorporated herein.

### TECHNICAL FIELD AND BACKGROUND OF THE INVENTION

The present invention relates to a structured wrap that can be releasably attached to an elongate object such as a luggage rack, roof rack, and/or spoiler of an automobile or boat ski tower, and/or on stand alone stationary components, such as a fence post, connector, or utility. In one embodiment of the invention, a structured wrap is adapted for releasable attachment to a cylindrical, cubical, cuboid, prism, rectangular, or similar type object, and can be used to display a desired advertising or promotional message.

Advertising and personalization of vehicles and automobiles is very popular and a common sight on American roadways. Today, there are many examples, such as personalized license tags, stickers, magnets, and car flags, that provide drivers the opportunity to engage in advertising or personalization on their vehicle. However, there are areas on vehicles that remain largely untouched by advertising or personalization, such as the roof or luggage racks as well as rear spoilers. Other methods of advertising or personalization commonly utilized today, such as painting and stickers, cannot be easily applied to the roof/luggage rack, ski towers or the rear spoiler component of a vehicle without substantial expense and effort. As such, there is an available area on many vehicles that previously has not been utilized for advertising or personalization.

### SUMMARY OF THE INVENTION

Therefore, one object of the present invention is to provide an advertising and personalization apparatus that allows for versatility by having an exterior cover that can be easily changed to meet personal preferences, without the need for painting or other more permanent direct means of advertising and personalization that can damage or permanently alter the vehicle or component. Another object of the invention is to provide an advertising apparatus that can be easily and releasably attached to standalone components, such as parking lot light poles, utility poles, shopping cart poles and chains, parking spot identification poles/markers, parking lot barriers, fence posts and fence connectors. The apparatus can simply be attached and utilized as long as desired and even offers the versatility of easily changing the exterior component of the apparatus as needed. Another object of the present invention is to provide an advertising/personalization device having an additional benefit of protection for the object to which it has been applied. These and other objects of the invention can be obtained in the preferred embodiments of the invention described below.

One embodiment of the present invention comprises a structured covering for a cylindrical, cubic, cuboid, prism, rectangular or similarly shaped object, such as a roof/luggage rack, rear spoiler, ski tower or similar type of object on a vehicle or a standalone component, such as a fence or pole. The covering allows for personalization as well as commercial based applications, such as advertising.

According to another embodiment of the invention, a structured wrap can be releasably attached to an elongate structural component such as a vehicle luggage rack, vehicle roof rack, vehicle spoiler, bar of a boat ski tower, parking lot light pole, utility pole, shopping cart pole, parking spot identification marker, parking lot barrier, fence post and/or a fence connector. The wrap includes an exterior cover comprised of cloth, plastic or similar material suitable for being applied to the structural component, and a hollow support cylinder or similarly shaped support member that attaches directly to the structural component. Hook and loop fasteners (VELCRO) or other suitable fastening mechanism is used to secure the exterior cover to the hollow support cylinder.

According to another embodiment of the invention, a method of decorating an elongate object comprises providing a structured wrap kit comprising a substantially cylindrical inner support member for positioning on an elongate object. The inner support member is comprised of a compressible material and has a hollow interior area and a slit opening. The kit includes a substantially rectangular outer cover for enclosing the inner support member. The cover has an outer surface and an inner surface, and indicia, such as a school, team or business name, is positioned on the outer surface. First and second complementary fasteners are positioned on the outer cover and adapted for releasable engagement with each other. The elongate object is pushed through the slit opening of the inner support member and the inner support member is positioned on the elongate object. The outer cover is wrapped around the inner support member with the inner surface of the cover facing the inner support member. The first and second complementary fasteners are attached to each other, so that the structured wrap is releasably attached to the elongate object and displays the indicia thereon.

### BRIEF DESCRIPTION OF THE DRAWINGS

FIG. 1A is a top plan view of an outer cover according to a preferred embodiment of the invention;

FIG. 1B is a bottom plan view of outer cover of FIG. 1A;

FIG. 2 is a perspective view of an inner support member according to a preferred embodiment of the invention;

FIG. 3 is an environmental view of the inner support member of FIG. 2;

FIG. 4 is an environmental view of a structured wrap according to a preferred embodiment of the invention;

FIG. 5 is another environmental view of the structured wrap of FIG. 4;

FIG. 6 is another environmental view of the structured wrap of FIG. 4; and

FIG. 7 is another environmental view of the structured wrap of FIG. 4;

### DESCRIPTION OF PREFERRED EMBODIMENTS OF THE INVENTION AND BEST MODE

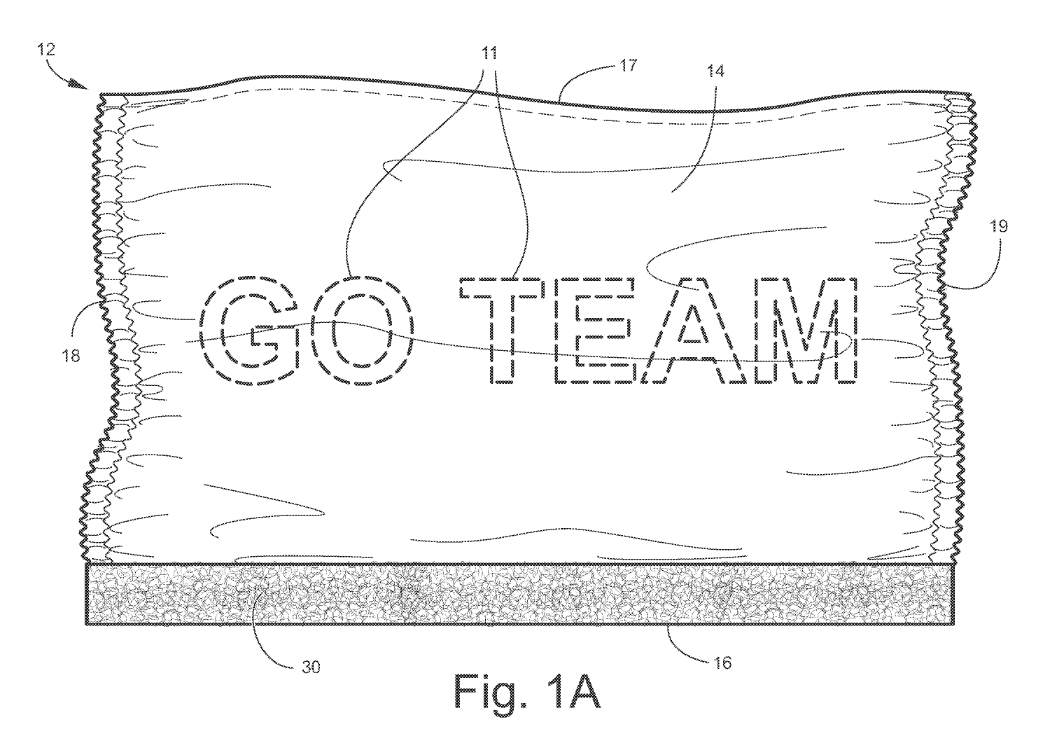

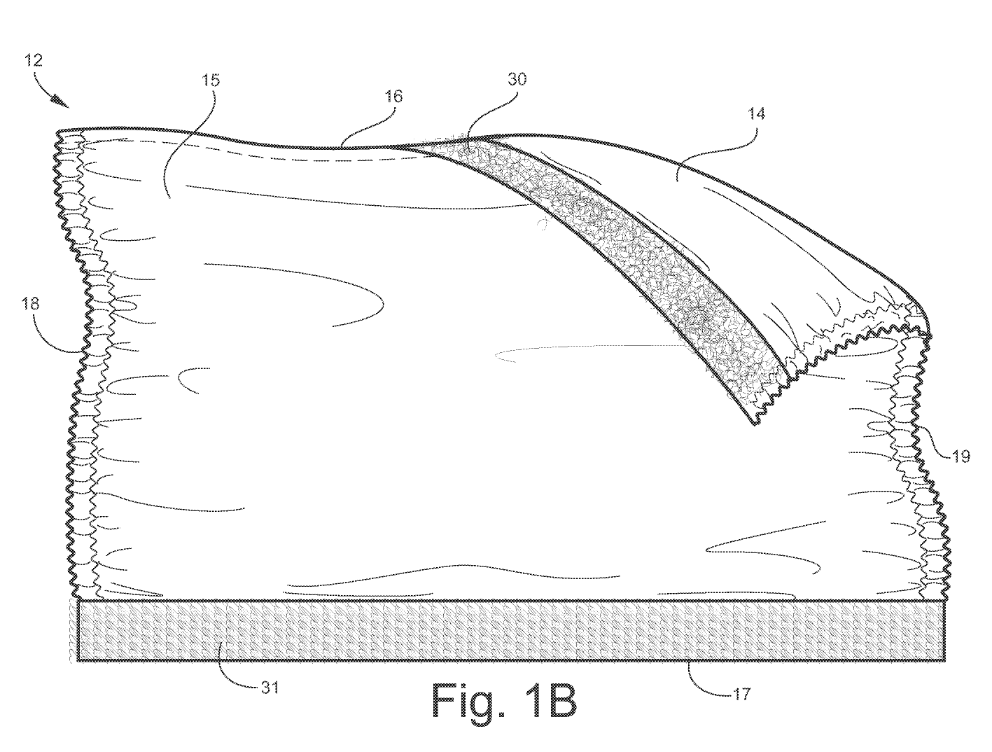

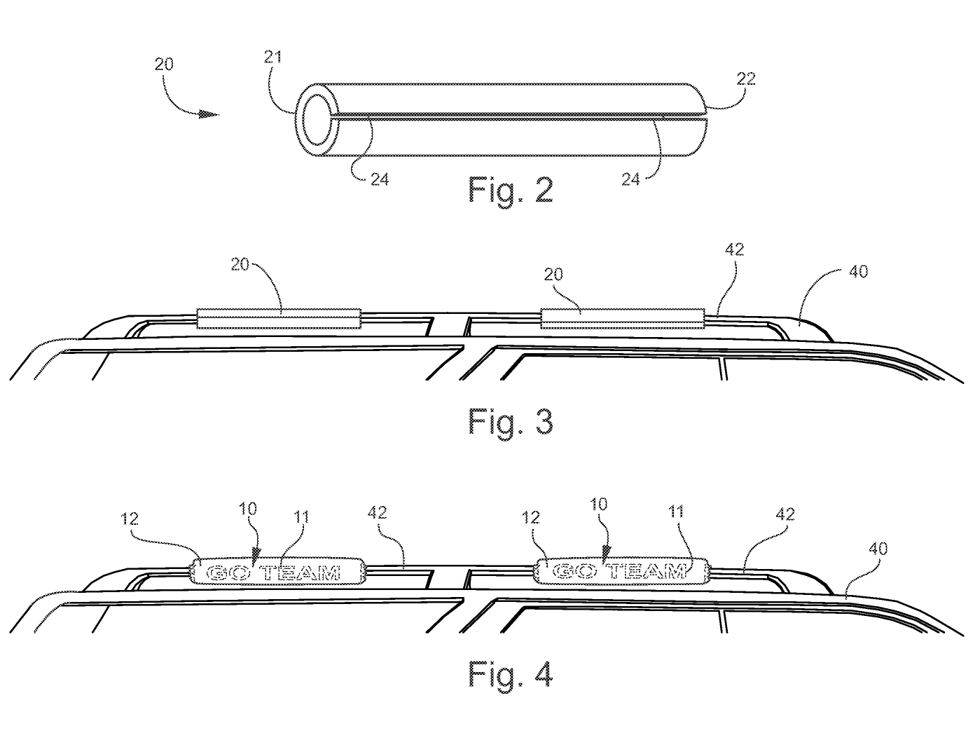

A structured wrap apparatus according to a preferred embodiment of the invention is illustrated in FIGS. 1A-7, and shown generally at reference numeral 10. The wrap 10 is generally comprised of an outer cover member 12, shown in FIGS. 1A and 1B, and an inner support member 20, shown in FIG. 2.

The cover 12 has an outer surface 14, shown in FIG. 1A, and an inner surface 15, shown in FIG. 1B. The cover 12 preferably has a substantially rectangular shape, as shown in FIGS. 1A and 1B. The cover 12 has opposed sides 16, 17 extending longitudinally along the length of the cover 12, and two shorter opposed ends 18, 19 extending substantially perpendicularly to opposed sides 16, 17, as shown in FIG. 1A. The cover can be made of cloth, polymeric plastic or other strong and flexible material suitable for wrapping around the inner support member 20.

The cover 12 has complementary fasteners positioned proximate the opposed sides 16, 17 that are adapted for releasable engagement with each other. The complementary fasteners can be hook and loop fasteners. As shown in FIGS. 1A and 1B, a section of loop fasteners 30 can be attached on the outer surface 14 of the cover 12 proximate side 16, and a section of hook fasteners 31 can be attached on the inner surface 15 proximate the opposed side 17. The hook and loop sections 31, 30 can be sewn to the cover 12. Alternatively, hook fasteners 31 can be attached on the outer surface 14 of the cover 12 proximate side 16, and loop fasteners 30 can be attached on the inner surface 15 proximate the opposed side 17. As shown in FIGS. 1A and 1B, an elastic material can be incorporated into the two short ends 18, 19 of the cover 12 to securely contain the inner support member 20 therein.

As shown in FIG. 1A, the outer surface 14 of the cover 12 can include distinguishing indicia 11 providing a personalized element to the wrap 10, such as the name of a favorite sports team. As used throughout this application, the term “indicia” refers broadly to any alpha-numeric symbol, graphic and/or combination thereof, including but not limited to the name and/or logo of a business, school and/or sports team, a person's name or initials, a brand name, and/or advertising slogan. The indicia 11 can be screen printed onto the outer surface 14 of the cover 12, or other suitable method can be used.

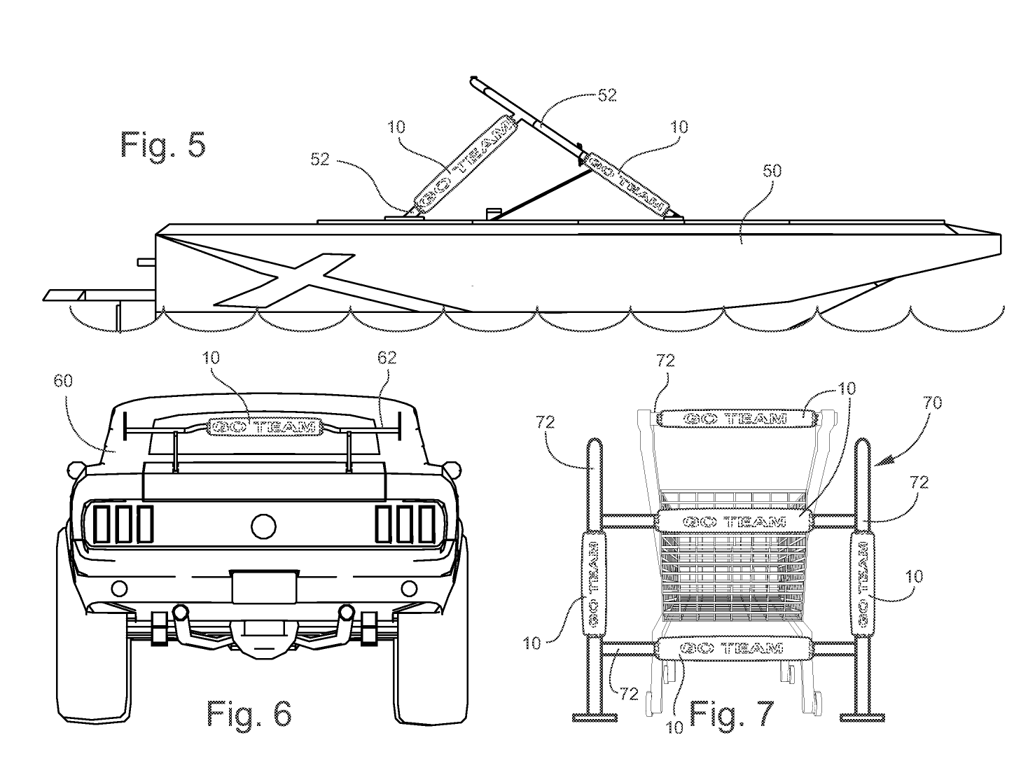

The indicia 11 can be a variety of words or phrases, such as “ROLL TIDE”, “ALABAMA”, or “WOLFPACK”, by which an individual can display his or her support for a particular school, sport team, and/or organization such as NASCAR. Also, the indicia can be a word, phrase or logo used for commercial advertising purposes. For example, a car dealership can display its name and/or logo of the manufacturer of their vehicles, such as “FORD” or “CHEVY.” Another example is a boat ski tower, shown in FIG. 5, and would allow for the boat manufacturer to advertise, such as “SKI NAUTIQUE.”

The inner support member can be made of a compressible material, such as polyurethane foam. The inner support member 20 can have a cylindrical shape, as shown in FIG. 2. The support member 20 can have a hollow interior, and can have openings at opposed ends 21, 22, as shown in FIG. 2. The inner support member 20 includes a slit opening 24 extending from one end 21 of the support member 20 to the other end 22. There can be an adhesive on both of the edges created by the slit opening 24, and peelable plastic covers can cover the adhesive to preserve the adhesive and prevent adhering the two edges until it is desired.

The outer cover 12 and the inner support member 20 can be packaged together as a kit. The packaged kit can be sold and distributed to end users.

FIGS. 3-7 illustrate various methods of using the wrap 10 according to preferred embodiments of the invention. As shown in FIGS. 3-4, the wrap 10 can be used on a roof or luggage rack 42 of an automobile 40. The inner support member 20 is positioned on the rack 42 by inserting the rack 42 through the slit opening 24. The support member 20 should be sized to wrap completely around the rack 42. If it is desired to permanently install the wrap 10 to the vehicle rack 42, then the user can peel off the peelable adhesive covers to expose the adhesive on the opposed edges of the support member 20 that define the slit opening 24, and the edges can be pressed together to permanently adhere them to each other. This is not necessary to secure the support member 20 to the vehicle rack 42. Next, the cover 12 is wrapped around the support member 20 with the outer surface 14 on the outside and the inner surface 15 inside, the split opening 24 of the support member 20 is lined up with opposed sides 16, 17 of the cover 12 and the hook fasteners 31 on side 17 are mated to the loop fasteners 30 on side 16 of the cover 12, thereby securing the cover 12 and inner the support 20 to the rack, as shown in FIG. 4. The wrap 10 can be adjusted so that the indicia 11 on the outer surface 15 of the cover 12 is clearly visible, as shown in FIG. 4.

The cover 12 is sufficiently wide, such as about four to thirty-six inches, to wrap around the circumference of the support member 20 in a secure manner. Furthermore, the length of the cover 12 is sufficient to cover a portion or all of the vehicle rack 40, such as about six to forty-eight inches. The two shorter sides 18, 19 of the cover 12 have elastic material enclosed to allow for tighter hold onto the support member 20. The support member 20 is of sufficient length and circumference to allow for the cover to be wrapped around in a secure manner.

A method of using the wrap 10 according to another embodiment of the invention is illustrated in FIG. 5. As shown in FIG. 5, the wrap 10 can be applied to the bars 52 of a ski tower that has been attached to a boat 50.

A method of using the wrap 10 according to another embodiment of the invention is illustrated in FIG. 6. As shown in FIG. 6, the wrap 10 can be attached to the rear spoiler 62 of an automobile 60.

A method of using the wrap 10 according to another embodiment of the invention is illustrated in FIG. 7. The wrap 10 can be attached to the bars 72 of a shopping cart return area 70, as shown in FIG. 7. As shown in FIGS. 5-7, the wrap 10 can be attached on horizontal, vertical or diagonal bars as desired by the individual.

It should be noted that the invention is not limited to use on objects shown in FIGS. 4-7. The wrap 10 can be attached to a variety of elongate objects, such as parking lot light poles, utility poles, shopping cart poles and chains, parking spot identification poles/markers, parking lot barriers, fence posts and fence connectors.

Advantages of the present invention include, without limitation, its unique ability to attach to a roof or luggage rack, rear spoiler, ski tower or other type of cylindrical object in a manner that allows for one to personalize the product or to use it for commercial purposes, such as advertisement. The wrap 10 is simple to attach to cylindrical, cubic, cuboid, prism, rectangular and similarly shaped objects, including standalone examples, and allows for a broad range of personalization or commercial applications. Additionally, the wrap 10 allows for versatility in that the exterior cover 12 can be easily changed and modified to meet one's specific needs and desires. Furthermore, the product is flexible in that it allows for use on a wide range of sizes, shapes and designs of roof/luggage racks, rear spoilers, ski towers or other similar cylindrical shaped objects either on a vehicle or as a standalone component. In addition to the promotion of personal interests or advertising, the wrap 10 provides protection from scratches or other damage to the object on which it is attached.

A structured wrap and method of using same are described above. Various changes can be made to the invention without departing from its scope. The foregoing description of embodiments and best mode of the invention are provided for the purpose of illustration only and not limitation—the invention being defined by the claims and equivalents thereof.

What is claimed is:

1. A structured wrap comprising:
(a) an inner support member adapted for positioning on an elongate object; and
(b) an outer cover adapted for enclosing the inner support member and releasably attaching the wrap to the elongate object.

2. The structured wrap according to claim 1, wherein the elongate object has a shape selected from the group consisting of substantially cylindrical, cuboid, prism and rectangular.

3. The structured wrap according to claim 2, wherein the inner support member has a shape selected from the group consisting of substantially cylindrical, cuboid, prism and rectangular.

4. The structured wrap according to claim 1, wherein the inner support member is comprised of a compressible material.

5. The structured wrap according to claim 4, wherein the inner support member is comprised of polyurethane foam.

6. The structured wrap according to claim 1, wherein the inner support member has a hollow interior area, and slit opening for receiving the elongate object therethrough.

7. The structured wrap according to claim 1, wherein the inner support member is substantially cylindrical, and includes a hollow interior area and a slit opening for receiving the elongate object therethrough.

8. The structured wrap according to claim 1, wherein the outer cover comprises at least one material selected from the group consisting of cloth and polymeric plastic.

9. The structured wrap according to claim 1, wherein the outer cover is substantially rectangular, and includes first and second longitudinally extending opposed sides, and first and second opposed ends extending substantially perpendicularly to the first and second opposed sides.

10. The structured wrap according to claim 9, further comprising first and second complementary fasteners positioned on the outer cover and adapted for releasable engagement with each other, whereby engagement of the first and second complementary fasteners maintains the cover on the inner support member.

11. The structured wrap according to claim 10, wherein the outer cover defines an outer surface and an inner surface, and the first fastener comprises a section of loop fasteners positioned on the outer surface proximate the first side of the cover, and the second fastener comprises a section of hook fasteners positioned on the inner surface of proximate the second side of the cover.

12. The structured wrap according to claim 1, wherein the elongate object comprises at least one selected from the group consisting of a vehicle luggage rack, vehicle roof rack, vehicle spoiler, bar of a boat ski tower, parking lot light pole, utility pole, shopping cart pole, parking spot identification marker, parking lot barrier, fence post and fence connector.

13. The structured wrap according to claim 1, wherein the outer cover defines an outer surface and an inner surface, and further comprising indicia on the outer surface.

14. A structured wrap kit comprising:
(a) a substantially cylindrical inner support member for positioning on an elongate object, the inner support member having a hollow interior area and a slit opening for receiving the elongate object therethrough; and
(b) a substantially rectangular outer cover adapted for enclosing the inner support member, the cover defining an outer surface and an inner surface and having indicia positioned on the outer surface; and
(c) first and second complementary fasteners positioned on the outer cover and adapted for releasable engagement with each other, whereby engagement of the first and second complementary fasteners maintains the outer cover on the inner support member and releasably attaches the wrap to the elongate object.

15. The kit according to claim 14, wherein the indicia comprises one or more selected from the group consisting of a school name, a sport team name, a business name, a brand name, an advertising slogan, and an individual's name.

16. The kit according to claim 14, wherein the outer cover includes first and second longitudinally extending opposed sides and first and second opposed ends extending substantially perpendicularly to the first and second opposed sides, and further wherein the first fastener is positioned on the outer surface proximate the first side of the outer cover, and the second fastener is positioned on the inner surface of proximate the second side of the cover.

17. The kit according to claim 16, wherein the first fastener comprises a section of loop fasteners, and the second fastener comprises a section of hook fasteners.

18. A kit according to claim 13, wherein the elongate object comprises at least one selected from the group consisting of a vehicle luggage rack, vehicle roof rack, vehicle spoiler, bar of a boat ski tower, parking lot light pole, utility pole, shopping cart pole, parking spot identification marker, parking lot barrier, fence post and fence connector.

19. A method of decorating an elongate object comprising the steps of:
(a) providing a structured wrap kit comprising:
(i) a substantially cylindrical inner support member for positioning on an elongate object, the inner support member comprised of a compressible material and having a hollow interior area and a slit opening; and
(ii) a substantially rectangular outer cover adapted for enclosing the inner support member, the cover defining an outer surface and an inner surface and having indicia positioned on the outer surface; and
(iii) first and second complementary fasteners positioned on the outer cover and adapted for releasable engagement with each other;
(b) inserting the elongate object through the slit opening of the inner support member the elongate member and positioning the inner support member on the elongate object;
(c) wrapping the outer cover around the inner support member with the inner surface of the cover facing the inner support member; and
(d) engaging the first and second complementary fasteners, whereby the structured wrap is releasably attached to the elongate object and displays the indicia thereon.

20. The method according to claim 19, wherein the elongate object comprises at least one selected from the group consisting of a vehicle luggage rack, vehicle roof rack, vehicle spoiler, bar of a boat ski tower, parking lot light pole, utility pole, shopping cart pole, parking spot identification marker, parking lot barrier, fence post and fence connector.
